(19) United States
(12) Patent Application Publication
(10) Pub. No.: US 2008/0179484 A1
(43) Pub. Date: Jul. 31, 2008

(54) METHODS AND SYSTEMS FOR AN ELECTRONIC DEVICE AND A STAND

(76) Inventor: David Quijano, Magnolia, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/669,178

(22) Filed: Jan. 31, 2007

(51) Int. Cl. F16M 11/00

(52) U.S. Cl. 248/451

(57) ABSTRACT

A system is provided that includes an electronic device and a stand for the electronic device. The electronic device comprises multiple sets of contact points compatible with the stand, each set of contact points being associated with a different orientation for the electronic device. The stand selectively interfaces with one of the multiple sets of contact points to stabilize the electronic device.

### BACKGROUND

A lightweight electronic device such as a thin client or a modem can be placed on a desktop or other location. As cables are attached to or unattached from the device, the stability of the device is affected (i.e., the device may tip forward, backward or to the side). Also, the environment around the device may affect its stability. For example, objects or users near the device may interact with the device (or the cables) causing the device to become unstable.

### BRIEF DESCRIPTION OF THE DRAWINGS

For a detailed description of exemplary embodiments of the invention, reference will now be made to the accompanying drawings in which:

FIGS. 1A-1D show a device stand in accordance with embodiments;

FIG. 2 shows a system in accordance with embodiments;

FIGS. 3A-3B show alternative setups for the system of FIG. 2 in accordance with embodiments;

FIG. 4 shows a method in accordance with embodiments; and

FIG. 5 shows another method in accordance with embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Embodiments relate to devices that can selectively be placed in various vertical orientations or horizontal orientations. If a vertical orientation is selected for the device, a stand is used to prevent the device from tipping over when external forces are applied to the device. In at least some embodiments, the stand supports different vertical orientations of the device. If external forces are applied in certain directions, the stand also enables the device to rotate while in the stand without becoming unstable. If a horizontal orientation is selected for the device, the stand is not needed. In at least some embodiments, the device and the stand are configured to facilitate joining or disjoining the device and the stand. For example, a user may simply pull the device and the stand apart or push the device and the stand together.

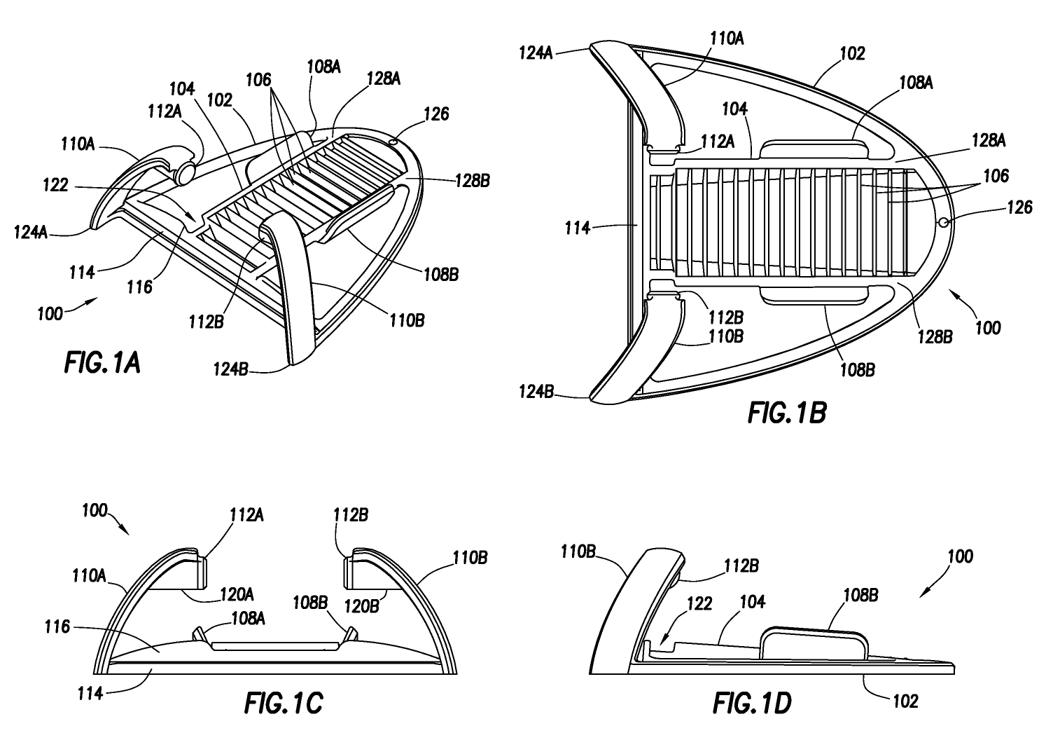

FIGS. 1A-1D show a device stand 100 in accordance with embodiments. As shown in FIGS. 1A and 1B, the device stand 100 comprises a base 102. In at least some embodiments, the base 102 has a curved portion with two ends 124A and 124B. The curved portion has two sides which extend outwardly away from a focal point 126 (i.e., the width of the base 102 increases as the distance from the focal point 126 increases) until the ends 124A and 124B are reached. In at least some embodiments, the sides of the base 102 can be joined together. For example, FIGS. 1A and 1B show the sides of the base 102 joined by a base member 114 before reaching the ends 124A and 124B. Alternatively, the base member 114 could join the sides of the base 102 at the ends 124A and 124B.

In alternative embodiments, the base 102 may comprise other straight portions or curved portions which provide stability. For example, the base 102 could comprise some or all of a rectangular shape, a trapezoidal shape, an elliptical shape, or other shapes. Regardless of the shape, the base 102 could be open ended rather than closed (e.g., base member 114 could be omitted).

In some embodiments, the stand 100 comprises a platform 104 that extends along the base 102. In FIG. 1A, the platform 104 extends from points 128A and 128B on the curved portion of the base 102 to the base member 114. In at least some embodiments, the platform 104 is inclined (e.g., the platform 104 is higher at the base member 114 than at points 128A and 128B) to increase stability of a device in a certain direction. As shown in FIGS. 1A and 1C, a platform support member 116 can be positioned above the base member 114 to support the platform 104 in an inclined position. Even if the base member 114 is omitted, the platform support member 116 can extend to and be sustained by the sides of the base 102. Alternatively, the platform support member 116 does not extend to the sides of the base 102 but does extend downward to the same level as the base 102 (i.e., a desk surface would contact the base 102 and the platform support member 116).

In at least some embodiments, lateral support members 108A and 108B can extend along some or all of the platform 104 to support the sides of a device. In FIGS. 1A-1B, the platform 104 comprises a plurality of spaced support surfaces 106 configured to support a device while enabling air to pass through the platform 104. In alternative embodiments, the platform 104 may comprise other vented surfaces or solid surfaces. As shown in FIGS. 1A and 1D, a gap 122 is also provided along the platform 104. The gap 122 enables a device to rotate without interference from the platform 104 as will later be described.

As shown in FIGS. 1A-1C, the stand 100 comprises two arms 110A and 110B that extend upwardly from the base 102 to a height above the platform 104. Although not required, the arms 110A and 110B may extend upwardly from the widest portion of the base 102. The arms 110A and 110B are used to stabilize a device by contacting opposite sides of the device. In at least some embodiments, the arms 110A and 110B are angled inwardly from the ends 124A and 124B of the base 102 towards a height above the gap 122. As shown in FIGS. 1B and 1C, contact points (e.g., stubs or recesses) 112A and 112B can be positioned respectively at the end of the arms 110A and 110B to contact a device. As shown in FIG. 1C, the arms 110A and 110B are curved inwardly until the width between the contact points 112A and 112B is approximately the width of the device or the width of the platform 146. In at least some embodiments, the contact points 112A and 112B are stubs that fit into recesses of a device to improve stability. In alternative embodiments, the contact points 112A and 112B are recesses that interface with stubs on the device.

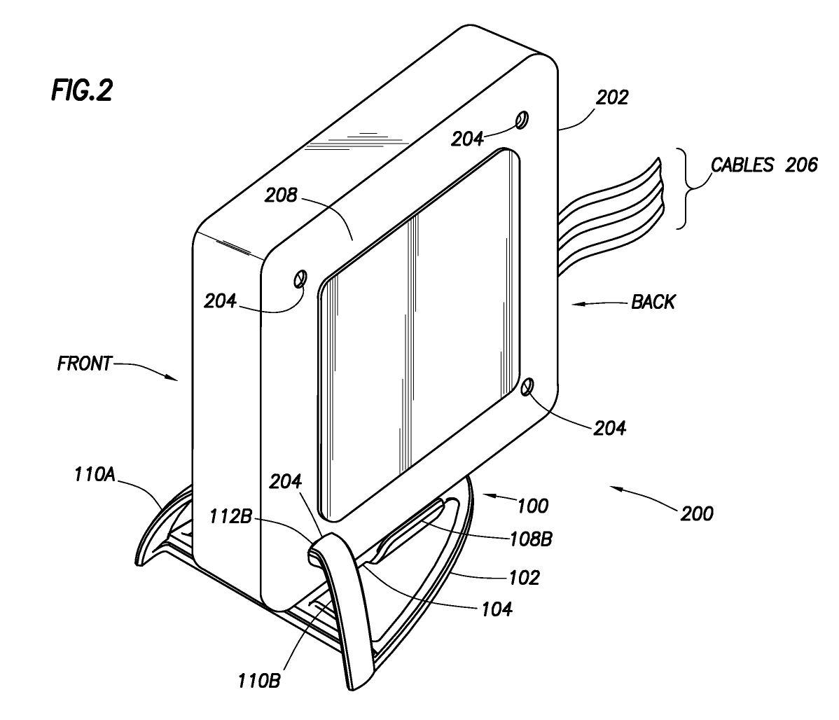

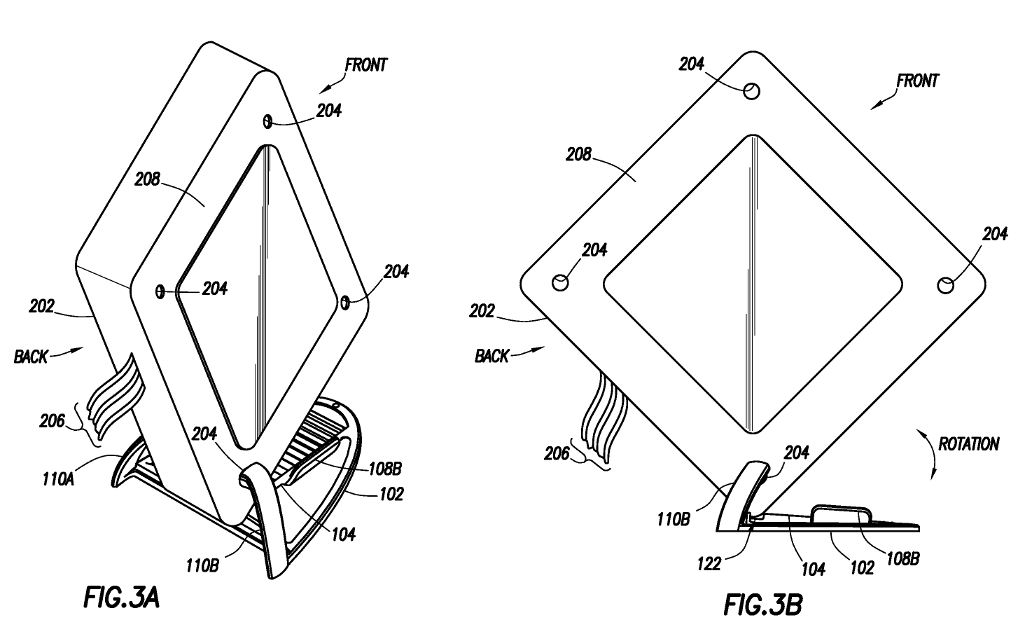

FIG. 2 shows a system 200 in accordance with embodiments. As shown in FIG. 2, the system 200 comprises a device 202 inserted into the stand 100. In at least some embodiments, the device 202 represents a thin client. Alternatively, the device 202 could represent a modem or another lightweight electronic device. As shown, the device 202 comprises a plurality of recesses 204 on the surface (housing) 208 of the device 202. The recesses 204 are located near each corner of the device 202 and could be included on both sides of the device 202. Other locations for the recesses 204 are also possible. In at least some embodiments, multiple sets of contact points (recesses or stubs) are included on the device 202. For example, each set of recesses 204 may receive the contact points 112A and 112B of the stand 100 when the device 202 is joined with the stand 100. The recesses 204 on either side of the device 202 can optionally be covered by rubber feet (not shown) that enable the device 202 to be placed on a surface (e.g., a desktop) in a horizontal orientation (i.e., the rubber feet would contact the surface). In such case, the rubber feet would prevent the housing of the device 202 from contacting the surface and would help prevent movement of the device 202 on the surface 208. The recesses 204 discussed in FIGS. 2 and 3A-3B could alternatively be stubs. In such case, the contact points 112A and 112B of the stand 100 could be recesses that receive the stubs. The stubs on the device 202 may or may not be covered with feet if the device 202 is to be placed in a horizontal orientation.

As shown, the device 202 is able to rest on the platform 104 with the arms 110A and 110B in contact with recesses 204 near the lower front of the device 202. In alternative embodiments, the arms 110A and 110B could be in contact with other recesses 204 (e.g., recesses near the upper front, recesses near the upper back or recesses near the lower back) of the device 202. Additionally, the orientation of the device 202 can be flipped (i.e., the contact point 112A can fit into a recess 204 previously occupied by the contact point 112B and vice versa by flipping the device 202).

If the platform 104 is inclined, the device 202 can rest on the platform 104 at an angle which helps stabilize the device 202 against external forces received in the direction opposite the incline. Furthermore, the base 102 of the stand 100 helps stabilize the device 202 against external forces that would otherwise cause the device 202 to tip over sideways. Furthermore, the lateral support members 108A and 108B of the platform 104 can help stabilize the device 202 by contacting the sides of the device 202 when the device 202 is resting on the platform 104.

In at least some embodiments, the environment of the system 200 can exert external forces on the device 202. For example, cables 206 can be attached to or unattached from the device 202. Also, objects or users near the device may interact with the device 202 (or the cables 206) causing external forces to be exerted on the device 202. The stand 100 enables the device 202 to maintain stability in such an environment. Otherwise, the device 202 could tip over, potentially damaging external or internal components.

FIGS. 3A-3B show alternative setups for the system 200 of FIG. 2 in accordance with embodiments. As shown in FIG. 3A, the arms 110A and 110B of the stand 100 are in contact with recesses 204 near the lower back or upper back of the device 202. In other words, the device 202 of FIG. 3A may or may not have been flipped (i.e., if flipped, the recesses 204 of FIG. 3A would correspond to the recesses that are not shown in FIG. 2 because they are on the opposite side of the device 202). In FIG. 3A, the device 202 does not rest on the platform 104 due to external forces on the device 202 (e.g., forces due to the cables 306). Instead, the device 202 is rotated off the platform 104 and may or may not still contact the lateral support members 108A and 108B. Even though the device 202 is rotated off the platform 104, the stability of the device 202 is maintained by the arms 110A and 110B which continue to contact the device 202 via the contact points described previously. In other words, the base 102 with the arms 110A and 110B can stabilize the device 202 even if external forces lift or rotate the device 202 off the platform 104.

In FIG. 3B, the device 202 has been rotated significantly yet is stabilized by the base 102 and the arms 110A and 110B. The lower corner of the device 202 is able to move within the gap 122 described for FIGS. 1A and 1D instead of contacting the platform 104. Thus, device 202 can be rotated as needed without affecting the stability of the device 202 or the compatibility of the device 202 with the stand 100. In some cases, a user may purposely select to position the device 202 in any of a variety of orientations. As previously mentioned, the device 202 can be oriented with the stand 100 using different sets of recesses 204 (or stumps) and/or can be rotated as needed.

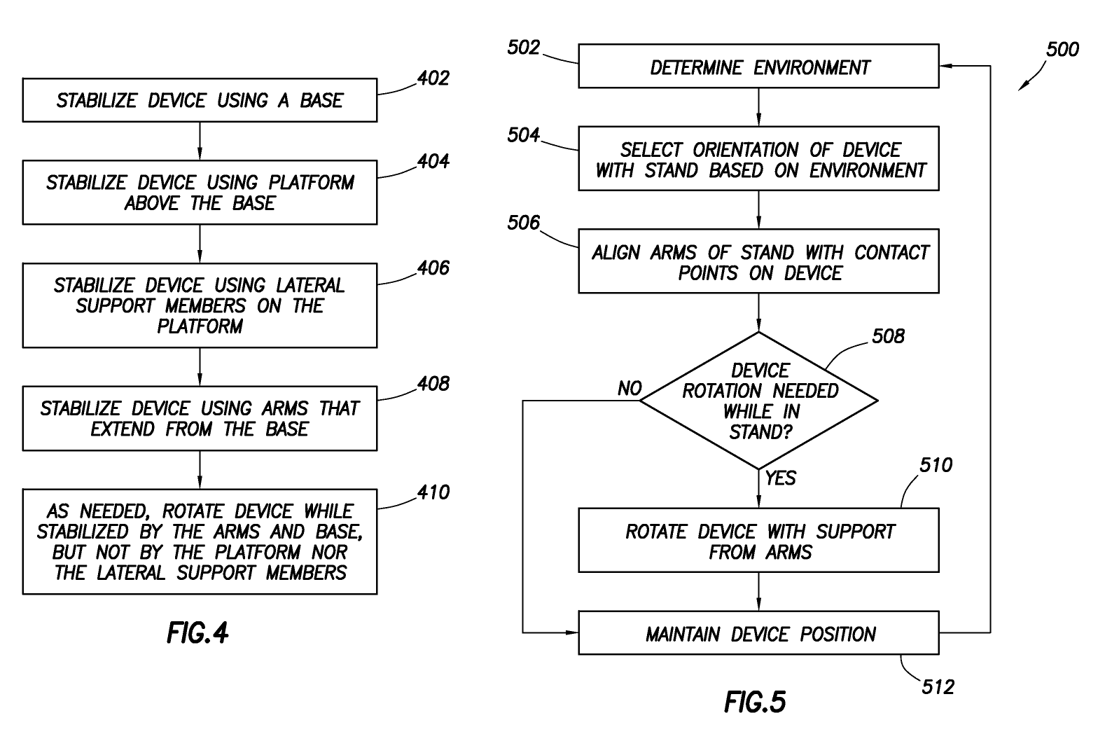

FIG. 4 illustrates a method 400 in accordance with embodiments. The method 400 comprises stabilizing a device using a base (block 402). The base, for example, may be widest near an area where the arms 110A and 110B are located. At block 404, the device is stabilized using a platform above the base. In at least some embodiments, the platform is inclined and the device is able to rest on the platform. At block 406, the device is stabilized using lateral support members on the platform. The lateral support members contact the sides of the device when the device rests on the platform. At block 408, the device is stabilized using arms that extend from the base. The arms may extend upward and inward from the base to reach a height above a gap in the platform. As needed, the device is rotated while stabilized by the arms and the base, but not by the platform nor the lateral support members (block 410). The gap could enable the device to be rotated without interference from the platform. The method steps could be performed in a different order or certain steps could be omitted.

FIG. 5 illustrates another method 500 in accordance with embodiments. The method 500 comprises determining an environment (block 502) and selecting an orientation of a device with a stand based on the environment (block 504). As an example, the device may have multiple sets of recesses or stubs (e.g., four sets) that enable the device to contact the stand in different vertical orientations. Environment factors such as cables, objects, space on a desktop, or other factors could lead a user to select a particular vertical orientation for the device. If a horizontal orientation is selected for the device, the stand is not used. At block 506, the arms of the stand are aligned with contact points on the device. The contact points may be recesses or stubs. By aligning the arms with the contact points, the device becomes stabilized via contact with the arms. If the device needs to be rotated while in the stand (determination block 508), the device is rotated with support from the arms (block 510). In other words, the arms stabilize the device even if the device is being rotated or is in a rotated position. If the device does not need to be rotated while in the stand (determination block 508) or the device was already rotated at block 510, the device position can be maintained (block 512). As desired, the method 500 can be repeated.

The above discussion is meant to be illustrative of the principles and various embodiments of the present invention. Numerous variations and modifications will become apparent to those skilled in the art once the above disclosure is fully appreciated. For example, the stand 100 described herein may be a one-piece stand made from plastic. Alternatively, one or more of the components of the stand 100 (e.g., the arms, the contact points, the platform, the lateral support members, the base) could be detachable. Different variations of components, fasteners, and/or materials used for the stand could be implemented. It is intended that the following claims be interpreted to embrace all such variations and modifications.

What is claimed is:

1. A system, comprising:
an electronic device; and
a stand for the electronic device;
wherein the electronic device comprises multiple sets of contact points compatible with the stand, each set of contact points being associated with a different orientation for the electronic device;
wherein the stand selectively interfaces with one of the multiple sets of contact points to stabilize the electronic device.

2. The system of claim 1 wherein each set of contact points comprises a first recess and a second recess and wherein the first and second recesses are on opposite sides of the electronic device.

3. The system of claim 2 wherein the stand comprises a first arm and a second arm, each arm having a contact stub that fits into either of the first and second recesses associated with each set of contact points.

4. The system of claim 1 wherein each set of contact points comprises a first stub and a second stub and wherein the first and second stubs are on opposite sides of the electronic device.

5. The system of claim 4 wherein the stand comprises a first arm and a second arm, each arm having a recess that receives either of the first and second stubs associated with each set of contact points.

6. The system of claim 1 wherein, if the electronic device is placed in a horizontal orientation on a surface, the stand is not used.

7. The system of claim 6 wherein, if the electronic device is placed in a horizontal orientation on the surface, some of the contact points touch the surface.

8. The system of claim 6 wherein, if the electronic device is placed in a horizontal orientation on the surface, feet are placed over at least some of the contact points to touch the surface.

9. The system of claim 1 wherein the stand comprises a plurality of arms, the arms selectively interface with one of the multiple sets of contact points to stabilize the electronic device and wherein the electronic device is able to rotate while stabilized by the arms.

10. The system of claim 1 wherein the stand selectively maintains the electronic device in an inclined rest position and enables the electronic device to rotate while stabilized.

11. A stand for an electronic device, the stand comprising:
a base;
a platform coupled to the base, at least some of the base being wider than the platform; and
two arms extending upward from the base to a height above the platform,
wherein, if an electronic device is joined with the stand, the platform enables the electronic device to maintain a resting position and wherein the two arms enable the electronic device to rotate off the platform while being stabilized by the two arms and the base.

12. The stand of claim 11 wherein the platform is inclined and enables the electronic device to maintain an inclined resting position.

13. The stand of claim 11 wherein each arm comprises a contact point that interfaces with the electronic device.

14. The stand of claim 11 wherein the contact point comprises one of a stub and a recess.

15. The stand of claim 11 wherein the platform is vented.

16. The stand of claim 11 wherein the platform comprises at least two lateral support members and wherein, if the electronic device is in the resting position, each lateral support member contacts a side surface of the electronic device.

17. The stand of claim 11 wherein the stand is a one-piece stand made from plastic.

18. A method, comprising:
selecting an orientation of an electronic device based on an environment;
if a vertical orientation for the electronic device is selected, joining the electronic device with a stand by aligning two arms of the stand with one of multiple sets of contact points on the device, each set of contact points being associated with a different orientation for the electronic device; and
stabilizing the electronic device in the selected orientation using the stand.

19. The method of claim 18 further comprising maintaining the electronic device in an inclined resting position using the stand.

20. The method of claim 18 further comprising selectively rotating the electronic device while the electronic device is stabilized by the arms.

21. The method of claim 20 further comprising maintaining the electronic device in a rotated position while the electronic device is stabilized by the arms.

22. The method of claim 20 further comprising selectively changing the orientation of the device by disjoining the stand from the electronic device and aligning the two arms of the stand with another of the multiple sets of contact points on the electronic device.
